(19) United States
(12) Patent Application Publication
(10) Pub. No.: US 2026/0121523 A1
(43) Pub. Date: Apr. 30, 2026

(54) MULTI-LEVEL POWER FACTOR CORRECTION CIRCUIT AND SURGE PROTECTION CONTROL METHOD THEREOF

(71) Applicant: Delta Electronics (Thailand) Public Company Limited, Samutprakarn (TH)

(72) Inventors: Kai Dong, Shanghai (CN); Xujinbo Zhang, Shanghai (CN); Yichao Wang, Shanghai (CN); Yuhua Hu, Shanghai (CN)

(21) Appl. No.: 19/359,644

(22) Filed: Oct. 15, 2025

(30) Foreign Application Priority Data
Oct. 24, 2024 (CN) 202411495685.1

(51) Int. Cl. H02M 1/42; H02M 1/32

(52) U.S. Cl. CPC H02M 1/4233; H02M 1/32; H02M 1/4266

(57) ABSTRACT

A multi-level power factor correction circuit and a surge protection control method for the multi-level power factor correction circuit are provided. When an input voltage is in the surge condition, the multi-level power factor correction circuit enters a surge protection mode under control of a control unit. In the surge protection mode, two first switches, two second switches, a first polarity switch and a second polarity switch are maintained in the turn-off state. Consequently, the input current of the multi-level power factor correction circuit will not flow through the flying capacitor. Since the voltage on the flying capacitor is very stable and not over-charged, the security of the multi-level power factor correction circuit is enhanced.

### CROSS-REFERENCE TO RELATED APPLICATION

This application claims priority to China Patent Application No. 202411495685.1 filed on Oct. 24, 2024, the entire content of which is incorporated herein by reference for all purposes.

### FIELD OF THE INVENTION

The present disclosure relates to a power factor correction circuit, and more particularly to a multi-level power factor correction circuit and a surge protection control method for the multi-level power factor correction circuit.

### BACKGROUND OF THE INVENTION

A two-level power factor correction (PFC) circuit includes polarity switches and power switches. In case that an input voltage or an input current is subjected to a surge condition, the polarity switches are controlled to be turned off to prevent the surge from damaging the two-level PFC circuit. However, in addition to the polarity switches and the power switches, the multi-level PFC circuit further includes at least one flying capacitor. In case that the input voltage or the input current is subjected to the surge condition, the surge current generated in response to the input voltage may still flow through the flying capacitor in the multi-level PFC circuit even if the polarity switches are turned off. This may cause the over-charging/over-discharging condition of the flying capacitor and potentially damage the multi-level PFC circuit. Consequently, the security of the conventional two-level PFC circuit is deteriorated.

In order to address the drawbacks of the conventional technologies, it is important to provide an improved multi-level power factor correction circuit and a surge protection control method for the multi-level power factor correction circuit.

### SUMMARY OF THE INVENTION

The present disclosure provides a multi-level power factor correction circuit and a control method for the multi-level power factor correction circuit. When an input voltage is in the surge condition, the multi-level power factor correction circuit enters a surge protection mode under control of a control unit. In the surge protection mode, two first switches, two second switches, a first polarity switch and a second polarity switch are maintained in the turn-off state. Consequently, the input current of the multi-level power factor correction circuit will not flow through the flying capacitor. Since the voltage on the flying capacitor is very stable and not over-charged, the security of the multi-level power factor correction circuit is enhanced.

In accordance with an aspect of the present disclosure, a multi-level power factor correction circuit is provided. The multi-level power factor correction circuit is an N-level power factor correction circuit, wherein N is an integer greater than or equal to 3. The multi-level power factor correction circuit includes a first input terminal, a second input terminal, a first output terminal, a second output terminal, an inductor, (N−1) first switches, (N−1) second switches, (N−2) flying capacitors, a first polarity switch, a second polarity switch and a control unit. The first input terminal and the second input terminal receive an input voltage. The first output terminal and the second output terminal provide an output voltage. A first terminal of the inductor is connected to the second input terminal. The (N−1) first switches are serially connected between a second terminal of the inductor and the second output terminal. The (N−1) second switches are serially connected between the second terminal of the inductor and the first output terminal. A first terminal of a k-th flying capacitor is connected with a node between a k-th first switch and a (k+1)-th first switch, and a second terminal of the k-th flying capacitor is connected with a node between a k-th second switch and a (k+1)-th second switch, wherein k is a positive integer less than or equal to (N−2). The first polarity switch is connected between the first input terminal and the first output terminal. The second polarity switch is connected between the first input terminal and the second output terminal. The control unit controls a working state of the multi-level power factor correction circuit according to the input voltage. When the input voltage is in a surge condition, the multi-level power factor correction circuit enters a surge protection mode under control of the control unit. In the surge protection mode, the first polarity switch, the second polarity switch, the (N−1) first switches and the (N−1) second switches are controlled to be turned off.

In accordance with another aspect of the present disclosure, a surge protection control method for a multi-level power factor correction circuit is provided, wherein the multi-level power factor correction circuit is an N-level power factor correction circuit, N is an integer greater than or equal to 3, and the multi-level power factor correction circuit includes a first input terminal, a second input terminal, a first output terminal, a second output terminal, an inductor, (N−1) first switches, (N−1) second switches, (N−2) flying capacitors, a first polarity switch and a second polarity switch. The first input terminal and the second input terminal receive an input voltage. The first output terminal and the second output terminal provide an output voltage. A first terminal of the inductor is connected to the second input terminal. The (N−1) first switches are serially connected between a second terminal of the inductor and the second output terminal. The (N−1) second switches are serially connected between the second terminal of the inductor and the first output terminal. A first terminal of a k-th flying capacitor is connected with a node between a k-th first switch and a (k+1)-th first switch, and a second terminal of the k-th flying capacitor is connected with a node between a k-th second switch and a (k+1)-th second switch, wherein k is a positive integer less than or equal to (N−2). The first polarity switch is connected between the first input terminal and the first output terminal. The second polarity switch is connected between the first input terminal and the second output terminal. The surge protection control method includes the following steps. Firstly, a working state of the N-level power factor correction circuit is controlled according to the input voltage. When the input voltage is in a surge condition, the N-level power factor correction circuit is controlled to enter a surge protection mode. In the surge protection mode, the first polarity switch, the second polarity switch, the (N−1) first switches and the (N−1) second switches are controlled to be turned off.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a circuit diagram illustrating the circuitry topology of a multi-level power factor correction circuit according to a first embodiment of the present disclosure;

FIG. 2A is a schematic circuit diagram illustrating a charging loop of the flying capacitor in the multi-level power factor correction circuit of the present disclosure;

FIG. 2B is a schematic circuit diagram illustrating a discharging loop of the flying capacitor in the multi-level power factor correction circuit of the present disclosure;

FIG. 3 is a schematic circuit diagram illustrating a current loop of the multi-level power factor correction circuit when the input voltage is in the surge condition;

FIG. 4 is a circuit diagram illustrating the circuitry topology of a multi-level power factor correction circuit according to a second embodiment of the present disclosure;

FIG. 5 is a schematic circuit diagram illustrating a first exemplary control unit of the multi-level power factor correction circuit shown in FIG. 1;

FIG. 6A is a schematic circuit diagram illustrating a second exemplary control unit of the multi-level power factor correction circuit shown in FIG. 1;

FIG. 6B is a schematic circuit diagram illustrating a third exemplary control unit of the multi-level power factor correction circuit shown in FIG. 1;

FIG. 7 is a flowchart illustrating a control method for the multi-level power factor correction circuit shown in FIG. 1;

FIG. 8 is a circuit diagram illustrating the circuitry topology of a multi-level power factor correction circuit according to a third embodiment of the present disclosure;

FIG. 9 is a circuit diagram illustrating the circuitry topology of a multi-level power factor correction circuit according to a fourth embodiment of the present disclosure; and

FIG. 10 is a circuit diagram illustrating the circuitry topology of a multi-level power factor correction circuit according to a fifth embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

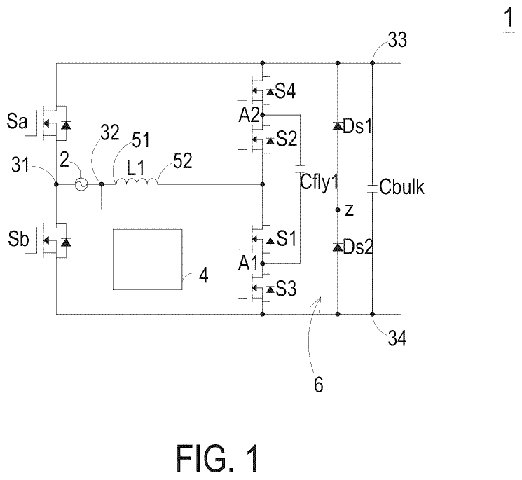

FIG. 1 is a circuit diagram illustrating the circuitry topology of a multi-level power factor correction circuit according to a first embodiment of the present disclosure. In this embodiment, the multi-level power factor correction circuit 1 is a three-level power factor correction circuit. That is, the number of levels of the multi-level power factor correction circuit 1 is 3. The multi-level power factor correction circuit 1 receives an input voltage provided from an AC power source 2 and provides electrical energy to a load (not shown). The multi-level power factor correction circuit 1 includes a first input terminal 31, a second input terminal 32, a first output terminal 33, a second output terminal 34, a first inductor L1, two first switches S1, S3, two second switches S2, S4, a flying capacitor Cfly1, a first polarity switch Sa, a second polarity switch Sb, a control unit 4 and an output capacitor Cbulk.

The first input terminal 31 and the second input terminal 32 are connected to two terminals of the AC power source 2, respectively. The first input terminal 31 and the second input terminal 32 are configured to receive an input voltage provided from the AC power source 2. The first output terminal 33 and the second output terminal 34 are configured to provide an output voltage to the load. The first inductor L1 has a first terminal 51 and a second terminal 52. The first terminal 51 of the first inductor L1 is connected to the second output terminal 32.

The two first switches S1 and S3 are serially connected between the second terminal 52 of the first inductor L1 and the second output terminal 34. The first switch S1 is connected to the second terminal 52 of the first inductor L1. The first switch S3 is connected to the second output terminal 34. The connection point between the first switches S1 and S3 is a first node A1. The two second switches S2 and S4 are serially connected between the second terminal 52 of the first inductor L1 and the first output terminal 33. The second switch S2 is connected to the second terminal 52 of the first inductor L1. The second switch S4 is connected to the first output terminal 33. The connection point between the second switches S2 and S4 is a second node A2. In other words, the second switch S4, the second switch S2, the first switch S1 and the first switch S3 are sequentially connected in series between the first output terminal 33 and the second output terminal 34. The flying capacitor Cfly1 is connected between the first node A1 and the second node A2.

In this embodiment, the first switches S1 and S3 and the second switches S2 and S4 are controlled to work in a PWM switching manner. Each of the first switch S1 and the second switch S4 receives a first driving signal. Each of the first switch S2 and the second switch S3 receives a second driving signal. The first driving signal and the second driving signal are complementary to each other.

The first polarity switch Sa is connected between the first input terminal 31 and the first output terminal 33. In the positive half cycle of the input voltage from the AC power source 2, the first polarity switch Sa is turned on. The second polarity switch Sb is connected between the first input terminal 31 and the second output terminal 34. In the negative half cycle of the input voltage from the AC power source 2, the second polarity switch Sb is turned on.

The switching frequency of each of the first polarity switch Sa and the second polarity switch Sb is much lower than the switching frequency of each of the first switches S1, S3 and the second switches S2, S4. Consequently, the first polarity switch Sa and the second polarity switch Sb are slow switches. According to the setting positions of the first polarity switch Sa and the second polarity switch Sb, the first polarity switch Sa and the second polarity switch Sb are selectively turned on. If the potential of the first input terminal 31 is lower than the potential of the second input terminal 32, the second polarity switch Sb is turned on. If the potential of the first input terminal 31 is greater than the potential of the second input terminal 32, the first polarity switch Sa is turned on. The output capacitor Cbulk is connected between the first output terminal 33 and the second output terminal 34. In an embodiment, the first switches S1, S3, the second switches S2, S4, the first polarity switch Sa and the second polarity switch Sb are power switches with anti-parallel diodes. For example, the power switches are JEFT transistors, MOSFET transistors or IGBT transistors. In some embodiments, these switches are power switches with built-in body diodes.

According to the state of the input voltage received by the first input terminal 31 and the second input terminal 32, the control unit 4 controls the working state of the multi-level power factor correction circuit 1. When the input voltage is subjected to a surge condition, the input voltage from the AC power source 2 exceeds the instantaneous overvoltage that the multi-level power factor correction circuit 1 can withstand. When the surge condition occurs, the multi-level power factor correction circuit 1 enters a surge protection mode under control of the control unit 4. Consequently, the two first switches S1, S3, the two second switches S2, S4, the first polarity switch Sa and the second polarity switch Sb are maintained in the turn-off state.

Please refer to FIG. 1 again. In this embodiment, the multi-level power factor correction circuit 1 further includes a bypass unit 6. The bypass unit 6 is connected between the first output terminal 33 and the second output terminal 34. The bypass unit 6 includes a first diode Ds1 and a second diode Ds2. The first diode Ds1 and the second diode Ds2 are sequentially connected between the first output terminal 33 and the second output terminal 34. The cathode of the first diode Ds1 is connected to the first output terminal 33. The cathode of the second diode Ds2 is connected to the anode of the first diode Ds1. The anode of the second diode Ds2 is connected to the second output terminal 34. The connection point between the cathode of the second diode Ds2 and the anode of the first diode Ds1 is a diode midpoint Z. The diode midpoint Z is connected to the second input terminal 32 (i.e., the first terminal 51 of the first inductor L1).

When the surge condition occurs, the input voltage will be greater than the voltage of the output capacitor Cbulk because the surge voltage has a very high peak. When a positive surge voltage is generated, the surge current loop is defined by the first diode Ds1, the output capacitor Cbulk and the second polarity switch Sb. When a negative surge voltage is generated, the surge current loop is defined by the first polarity switch Sa, the output capacitor Cbulk and the second polarity switch Sb. Since the surge current does not flow through the first switches S1, S3 and the second switches S2, S4, the switches will not be damaged by the surge current.

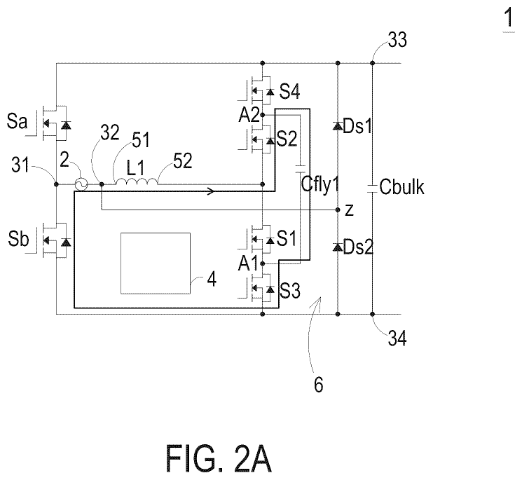

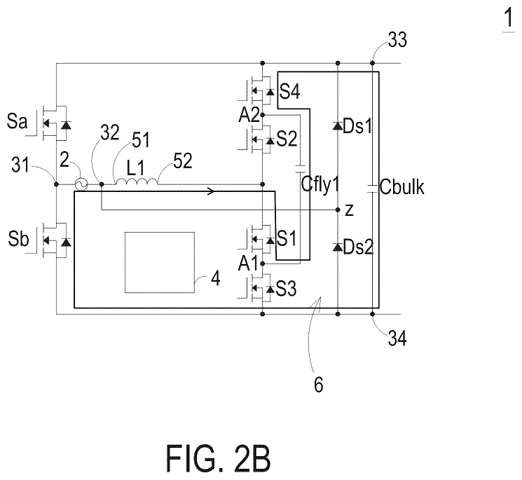

FIG. 2A is a schematic circuit diagram illustrating a charging loop of the flying capacitor in the multi-level power factor correction circuit of the present disclosure. FIG. 2B is a schematic circuit diagram illustrating a discharging loop of the flying capacitor in the multi-level power factor correction circuit of the present disclosure. In FIG. 2A and FIG. 2B, the multi-level power factor correction circuit 1 is operated normally, and the potential of the first input terminal 31 is lower than the potential of the second input terminal 32.

In the situation of FIG. 2A, the flying capacitor Cfly1 is charged by the AC power source 2. The AC current provided by the AC power source 2 flows through the first inductor L1, the second switch S2, the flying capacitor Cfly1, the first switch S3 and the second polarity switch Sb in sequence. In the situation of FIG. 2B, the flying capacitor Cfly1 discharges electricity. The current provided by the flying capacitor Cfly1 flows through the second switch S4, the output capacitor Cbulk, the second polarity switch Sb, the first inductor L1 and the first switch S1 in sequence.

When a positive surge voltage is generated, the peak of the surge voltage only lasts for a short time. However, since the generated current lasts for a long time, the input current is still large when the surge voltage ends. In the conventional power factor correction circuit, the on/off states of the polarity switch are controlled. The input current still flows through the body diode (or anti-parallel diode) of the second polarity switch Sb, and the current path is not changed. The larger input current may excessively charge and discharge the flying capacitor Cfly1. Since the voltage withstood by the switch is increased, the switch is possibly damaged.

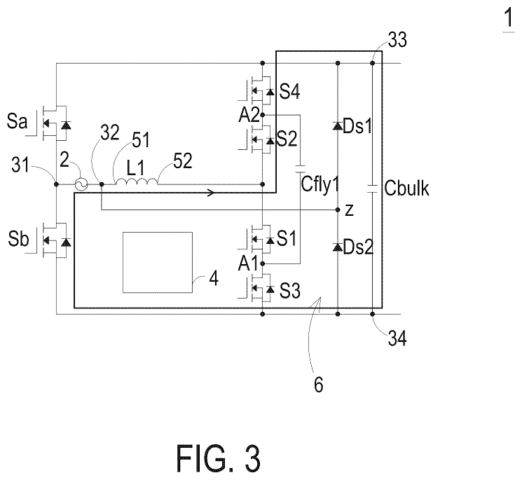

In order to avoid damage of the switch, the multi-level power factor correction circuit of the present disclosure is operated in the surge protection mode to change the current path. FIG. 3 is a schematic circuit diagram illustrating a current loop of the multi-level power factor correction circuit when the input voltage is in the surge condition. When the input voltage is subjected to the surge condition, the multi-level power factor correction circuit 1 enters the surge protection mode under control of the control unit 4. Consequently, the two first switches S1, S3, the two second switches S2, S4, the first polarity switch Sa and the second polarity switch Sb are maintained in the turn-off state. When the surge conditions shown in FIGS. 2A and 2B occur, the control method of the present disclosure can effectively avoid the damage of the switches. The input current flows through the first inductor L1, the body diodes (or anti-parallel diodes) of the second switches S2 and S4, the output capacitor Cbulk and the body diode (or anti-parallel diode) of the second polarity switch Sb in sequence, or the input current flows through the first inductor L1, the body diodes (or anti-parallel diodes) of the first switches S1 and S3, the output capacitor Cbulk and the body diode (or anti-parallel diode) of the first polarity switch Sa in sequence. When compared with the conventional power factor correction circuit, the input current of the multi-level power factor correction circuit 1 of the present disclosure will not flow through the flying capacitor Cfly1. Since the voltage on the flying capacitor Cfly1 is very stable and not over-charged or over-discharged, the security of the multi-level power factor correction circuit 1 is enhanced.

In the above embodiment, the potential of the first input terminal 31 is lower than the potential of the second input terminal 32, and the positive surge voltage is generated. It is noted that numerous modifications and alterations may be made while retaining the teachings of the disclosure.

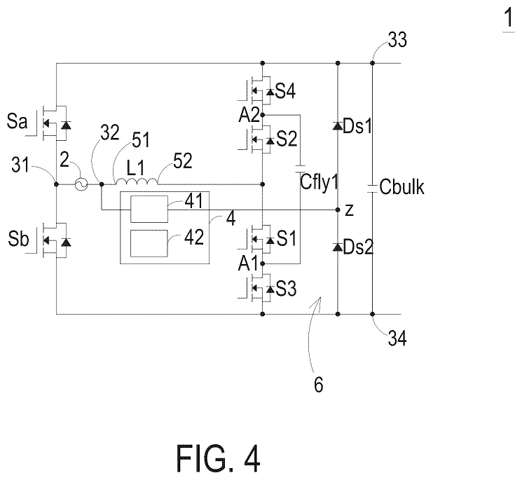

FIG. 4 is a circuit diagram illustrating the circuitry topology of a multi-level power factor correction circuit according to a second embodiment of the present disclosure. As shown in FIG. 4, the control unit 4 includes a surge current sampling module 41 and a surge determination module 42. The surge current flows to the output capacitor Cbulk through the first diode Ds1 or the second diode Ds2 of the bypass unit 6. The surge current sampling module 41 is used to sample the surge current and generate a surge current sampled signal Vi according to the surge current. The first terminal of the surge current sampling module 41 is connected to the diode midpoint Z between the first diode Ds1 and the second diode Ds2. The second terminal of the surge current sampling module 41 is connected to the second input terminal 32. The surge current sampling module 41 includes a current transformer or a resistor. The surge determination module 42 has a preset surge protection threshold Vt. In addition, the surge determination module 42 receives the surge current sampled signal Vi from the surge current sampling module 41. If the surge determination module 42 determines that the surge current sampled signal Vi is greater than the preset surge protection threshold Vt, a triggering signal is generated. In response to the triggering signal, the multi-level power factor correction circuit 1 is triggered to enter the surge protection mode. Consequently, the two first switches S1, S3, the two second switches S2, S4, the first polarity switch Sa and the second polarity switch Sb are maintained in the turn-off state under the control of a driving module (not shown) in the control unit 4.

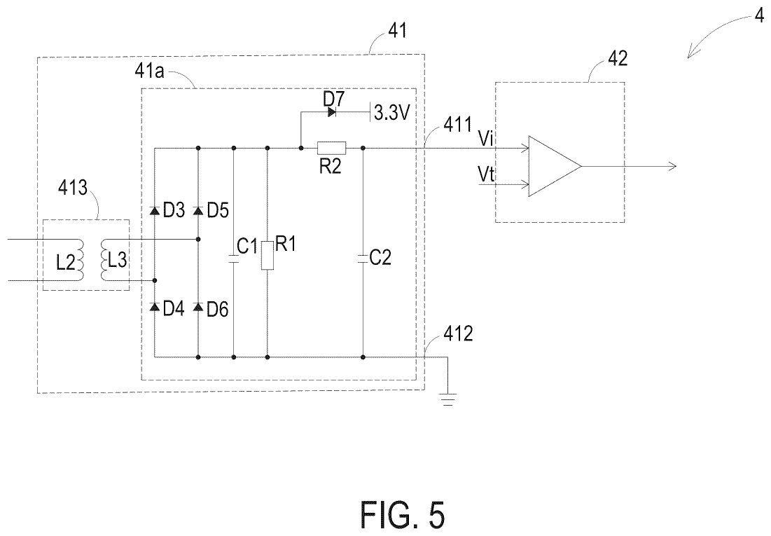

FIG. 5 is a schematic circuit diagram illustrating a first exemplary control unit of the multi-level power factor correction circuit shown in FIG. 1. As shown in FIGS. 1, 4 and 5, the surge current sampling module 41 further includes a sampling circuit 413 and a voltage shaping circuit 41a. The sampling circuit 413 samples the surge current and outputs the sampled current information to the voltage shaping circuit 41a, and the voltage shaping circuit 41a outputs the surge current sampled signal Vi according to the current information.

In this embodiment, the sampling circuit 413 is a current transformer. The current transformer includes a primary winding L2 and a secondary winding L3. The primary winding L2 is serially connected between the diode midpoint Z and the second input terminal 32.

Consequently, after the surge current flows through the primary winding L2, an induced current is generated by the secondary winding L3.

The voltage shaping circuit 41a is connected to the secondary winding L3 in the current transformer. After the electrical signal induced by the secondary winding L3 is shaped by the voltage shaping circuit 41a, the surge current sampled signal Vi is generated. In an embodiment, the voltage shaping circuit 41a includes a rectifier unit, a filtering circuit, a first sampling output terminal 411 and a second sampling output terminal 412. After the electrical signal induced by the secondary winding L3 is rectified by the rectifier unit, a DC electrical signal is generated. Then, the DC electrical signal is converted into the surge current sampled signal Vi through the filtering circuit.

In the voltage shaping circuit 41a, the rectifier unit includes a first rectifier diode D3, a second rectifier diode D4, a third rectifier diode D5 and a fourth rectifier diode D6. The first rectifier diode D3, the second rectifier diode D4, the third rectifier diode D5 and the fourth rectifier diode D6 are collaboratively formed as a rectifier bridge. The first terminal of the secondary winding L3 is connected to the midpoint between the first rectifier diode D3 and the second rectifier diode D4. The second terminal of the secondary winding L3 is connected to the midpoint between the third rectifier diode D5 and the fourth rectifier diode D6. The filtering circuit includes a first sampling capacitor C1, a first sampling resistor R1, a second sampling resistor R2 and a second sampling capacitor C2. The first sampling capacitor C1 and the first sampling resistor R1 are collaboratively formed as an RC parallel filtering circuit. The second sampling resistor R2 and the second sampling capacitor C2 are collaboratively formed as an RC series filtering circuit. The first sampling output terminal 411 is connected to the node between the second sampling resistor R2 and the second sampling capacitor C2. The second sampling output terminal 412 is connected to the ground terminal.

The surge current sampling module 41 further includes a diode D7. The anode of the diode D7 is connected to the node between the first sampling resistor R1 and the second sampling resistor R2. The cathode of the diode D7 receives the maximum allowable voltage for the surge current sampling module 41, e.g., 3.3 V. The second sampling resistor R2 is also connected to the first sampling output terminal 411. The second sampling capacitor C2 is connected between the first sampling output terminal 411 and the second sampling output terminal 412.

In a variant example, the sampling circuit 413 is implemented with a resistor. The two terminals of the resistor are connected between the diode midpoint Z and the second input terminal 32. In addition, the two terminals of the resistor are respectively connected with the two input terminals of the voltage shaping circuit 41a. That is, the first terminal of the resistor is connected to the midpoint between the first rectifier diode D3 and the second rectifier diode D4, and the second terminal of the resistor is connected to the midpoint between the third rectifier diode D5 and the fourth rectifier diode D6.

The surge determination module 42 includes a comparator. The first input terminal of the comparator is connected to the first sampling output terminal 411 of the surge current sampling module 41. The second input terminal of the comparator receives the preset surge protection threshold Vt. The output terminal of the comparator generates a triggering signal.

However, in some special situations, when the multi-level power factor correction circuit 1 is restored to the normal working state from the surge condition, the control unit 4 determines that the surge condition still occurs and the multi-level power factor correction circuit 1 is maintained in the surge protection mode. In an embodiment, the control unit 4 provides the function of determining whether the surge protection mode is erroneously triggered. If the control unit 4 determines that the surge protection mode is erroneously triggered, the multi-level power factor correction circuit 1 exits from the surge protection mode under control of the control unit 4.

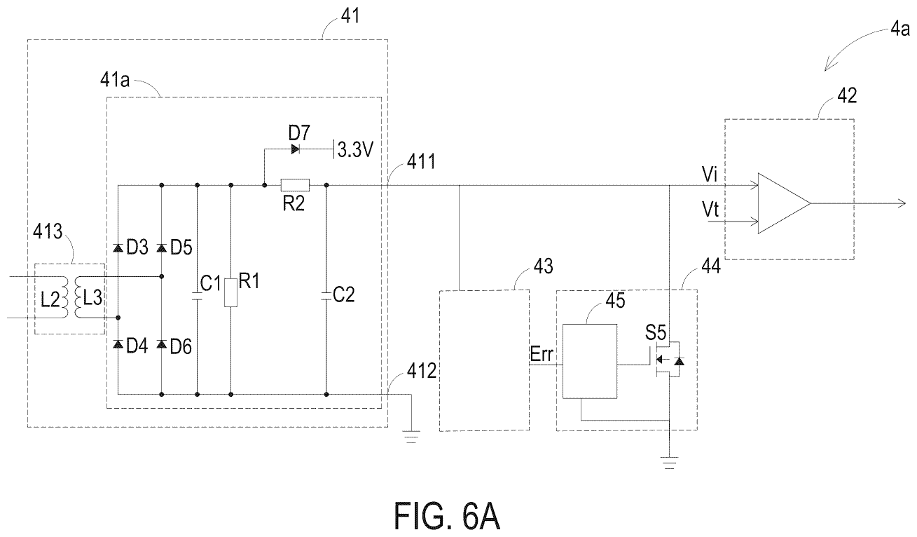

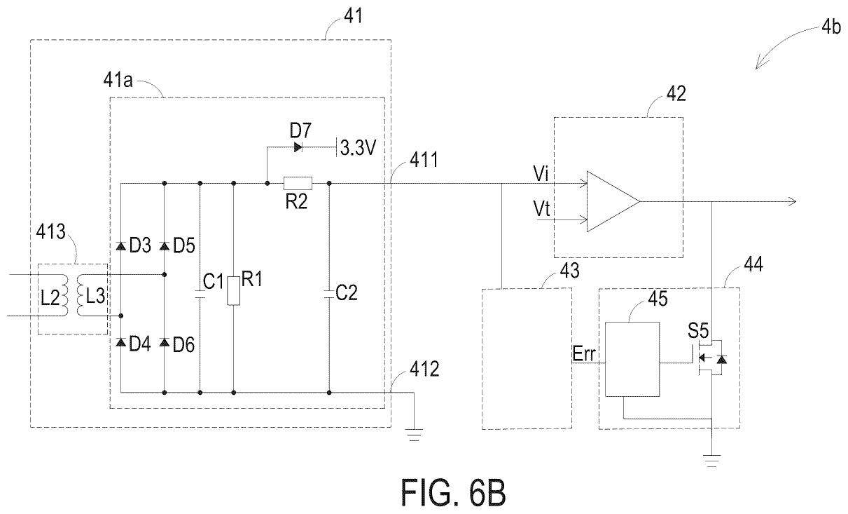

FIG. 6A is a schematic circuit diagram illustrating a second exemplary control unit of the multi-level power factor correction circuit shown in FIG. 1. As mentioned above in FIG. 5, the control unit 4 includes the surge current sampling module 41 and the surge determination module 42. In comparison with FIG. 5, the control unit 4a of this embodiment further includes an erroneous trigger determination module 43 and a masking module 44. The erroneous trigger determination module 43 receives the surge current sampled signal Vi from the surge current sampling module 41 and/or receives the input voltage sampled signal from the AC power source 2. According to the surge current sampled signal Vi and/or the input voltage sampled signal, the erroneous trigger determination module 43 determines whether the surge protection mode is erroneously triggered.

For example, according to the result of determining whether the surge current sampled signal Vi and/or the input voltage sampled signal is within a threshold range, the erroneous trigger determination module 43 determines whether the surge protection mode is erroneously triggered. That is, if the surge current sampled signal Vi and/or the input voltage sampled signal is within the threshold range, the erroneous trigger determination module 43 determines whether the surge protection mode is erroneously triggered. Meanwhile, the erroneous trigger determination module 43 generates an erroneous triggering signal Err. Whereas, if the surge current sampled signal Vi and/or the input voltage sampled signal is not within the threshold range, the erroneous trigger determination module 43 determines whether the surge protection mode is not erroneously triggered. For precisely confirming whether the surge protection mode is erroneously triggered, the erroneous trigger determination module 43 generates the erroneous triggering signal Err after some consecutive surge current sampled signals Vi and/or some consecutive input voltage sampled signals are all within the threshold range. For example, if M consecutive surge current sampled signals Vi and/or M consecutive input voltage sampled signals are all within the threshold range, the erroneous trigger determination module 43 determines whether the surge protection mode is erroneously triggered, and the erroneous trigger determination module 43 generates the erroneous triggering signal Err, wherein M is greater than or equal to 2. Whereas, if M consecutive surge current sampled signals Vi and/or M consecutive input voltage sampled signals are not all within the threshold range, the erroneous trigger determination module 43 determines whether the surge protection mode is not erroneously triggered.

Please refer to FIG. 6A again. The masking module 44 is connected to the erroneous trigger determination module 43. In addition, the masking module 44 is connected between the surge current sampling module 41 and the surge determination module 42. When the masking module 44 receives the erroneous triggering signal Err from the erroneous trigger determination module 43, the surge current sampled signal Vi from the surge current sampling module 41 is masked by the masking module 44. Consequently, the surge current sampled signal Vi is lower than the preset surge protection threshold Vt, and the triggering signal from the surge determination module 42 is invalid. Under this circumstance, the multi-level power factor correction circuit 1 exits from the surge protection mode. The two first switches S1 and S3, the two second switches S2 and S4, the first polarity switch Sa and the second polarity switch Sb are restored to the normal working state. In this context, the term “mask” used herein indicates that the signal is changed to an invalid state (e.g., a low-level state) or the signal is inactivated.

In an embodiment, the masking module 44 includes a driving circuit 45 and a masking switch S5. The masking switch S5 is connected between the output terminal of the surge current sampling module 41 and the ground terminal. The control terminal of the masking switch S5 receives the erroneous triggering signal Err from the erroneous trigger determination module 43 through the driving circuit 45. If the erroneous triggering signal Err is valid (e.g., in the high-level state), the masking switch S5 is controlled to be turned on. Consequently, the surge current sampled signal Vi is pulled down to be lower than the preset surge protection threshold Vt.

It is noted that the installation position of the masking module 44 may be varied according to the practical requirements. FIG. 6B is a schematic circuit diagram illustrating a third exemplary control unit of the multi-level power factor correction circuit shown in FIG. 1. In comparison with the control unit 4a of FIG. 6A, the masking module 44 in the control unit 4b of this embodiment is disposed between the output terminal of the surge determination module 42 and the ground terminal. When the triggering signal from the surge determination module 42 is masked by the masking module 44, the multi-level power factor correction circuit 1 exits from the surge protection mode. The operations of the masking module 44 in this embodiment are similar to those of the masking module 44 shown in FIG. 6A, and not redundantly described herein.

As mentioned above, the two first switches S1, S3, the two second switches S2, S4, the first polarity switch Sa and the second polarity switch Sb are controlled by the driving module (not shown) in the control unit 4. In a variant example, the masking module 44 is connected to the output terminal of the driving module to mask the driving signal from the driving module.

In an embodiment, the control unit is implemented with a pure software program. It is noted that the mechanism for masking the triggering signal and allowing the multi-level power factor correction circuit to exit from the surge protection mode is not restricted. In some embodiments, the sampling circuit 413 includes a sampling resistor for sampling associated signals.

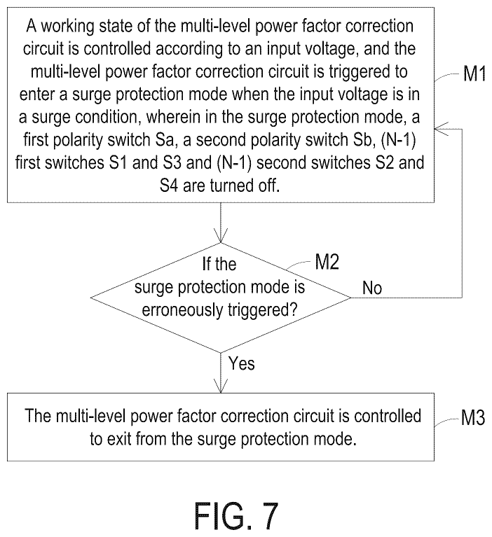

Please refer to FIG. 1, FIG. 2 and FIG. 7. FIG. 7 is a flowchart illustrating a control method for the multi-level power factor correction circuit shown in FIG. 1.

Firstly, in a step M1, a working state of the multi-level power factor correction circuit 1 is controlled according to an input voltage, and the multi-level power factor correction circuit 1 is triggered to enter a surge protection mode when the input voltage is in a surge condition, wherein in the surge protection mode, the a polarity switch Sa, a second polarity switch Sb, (N−1) first switches S1 and S3 and (N−1) second switches S2 and S4 are turned off.

Then, a step M2 is performed to determine whether the surge protection mode is erroneously triggered.

If the determining condition of the step M2 is satisfied, the multi-level power factor correction circuit 1 is controlled to exit from the surge protection mode (Step M3). Whereas, if the determining condition of the step M2 is not satisfied, the step M1 is repeatedly done.

In some embodiments, the preset surge protection threshold Vt is adjusted to avoid the erroneous triggering condition of the multi-level power factor correction circuit 1. For example, if the input voltage is the DC voltage and the input voltage suddenly loses power, the voltage of the output capacitor Cbulk will decrease. After the input voltage is restored to the normal level, the voltage of the output capacitor Cbulk (i.e., the output voltage) is lower than the input voltage, and a greater portion of the current will flow to the output side through the primary winding L2. Since the surge current sampled signal Vi induced by the secondary winding L3 is greater than the preset surge protection threshold Vt, the surge protection mode is erroneously triggered. Since the multi-level power factor correction circuit 1 is maintained in the surge protection mode, the input voltage cannot rise normally. In order to solve this problem, an erroneous triggering threshold Vsft is set in the control unit 4 according to the output current peak value of the multi-level power factor correction circuit 1 in the normal working state. The preset surge protection threshold Vt is greater than the erroneous triggering threshold Vsft. For example, the erroneous triggering threshold Vsft may be obtained according to the following formula (1):

$${V}_{sft} = \frac{{I}_{ou𝔱\_peak}}{{N}_{s}} {R}_{1} \qquad ( 1 )$$

In the above mathematic formula (1), V_{sft} is the preset erroneous triggering threshold, I_{out_peak} is the output current peak value of the multi-level power factor correction circuit 1 in the normal working state, Nₛ is the turns ratio of the turn number of the primary winding L2 to the turn number of the secondary winding L3, and R₁ is the resistance of the first sampling resistor.

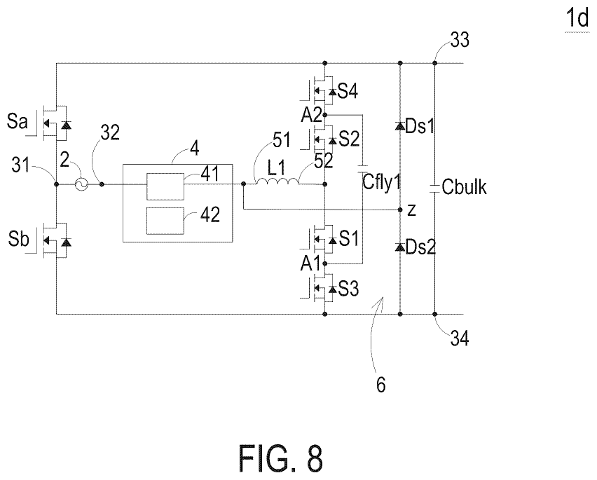

In some embodiments, the connecting relationship between the surge current sampling module 41 and associated components may be varied. FIG. 8 is a circuit diagram illustrating the circuitry topology of a multi-level power factor correction circuit according to a third embodiment of the present disclosure. In comparison with the multi-level power factor correction circuit 1 of FIG. 1, the surge current sampling module 41 of the control unit 4 in the multi-level power factor correction circuit 1d of this embodiment is connected between the second input terminal 32 and the first terminal 51 of the first inductor L1. In addition, the surge current sampling module 41 is connected between the second input terminal 32 and the diode midpoint Z. In this embodiment, the first terminal 51 of the first inductor L1 is connected with the diode midpoint Z.

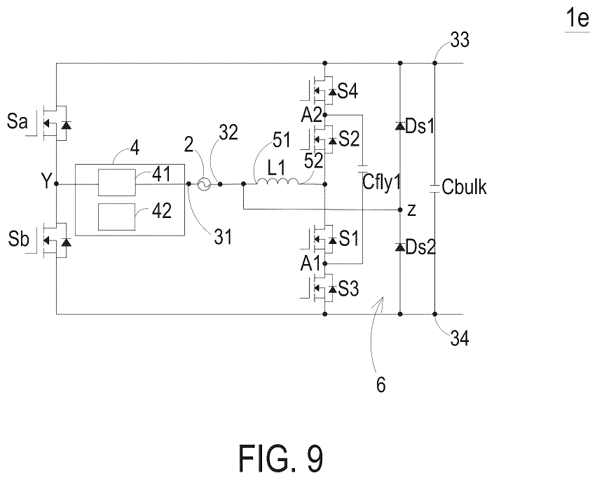

FIG. 9 is a circuit diagram illustrating the circuitry topology of a multi-level power factor correction circuit according to a fourth embodiment of the present disclosure. In comparison with the multi-level power factor correction circuit 1 of FIG. 1, the first terminal and the second terminal of the surge current sampling module 41 of the control unit 4 in the multi-level power factor correction circuit 1e of this embodiment are respectively connected with the switch midpoint Y between the two polarity switches Sa and Sb and the first input terminal 31. In this embodiment, the first terminal 51 of the first inductor L1 is connected with the diode midpoint Z.

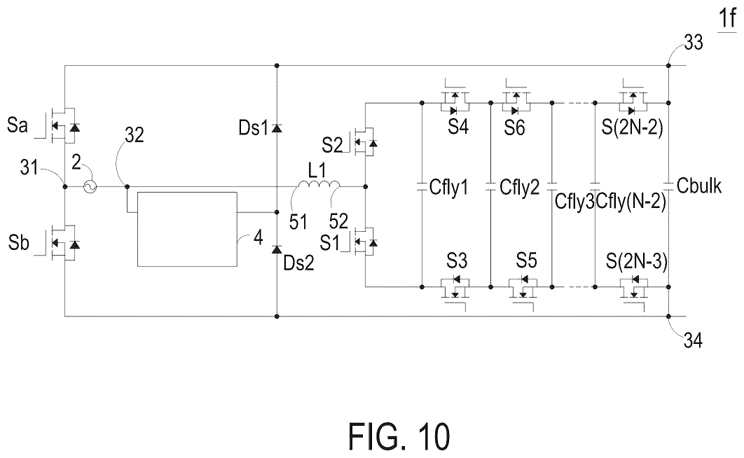

In the above embodiments, the multi-level power factor correction circuit 1 is a three-level power factor correction circuit. In some other embodiments, the number of levels of the multi-level power factor correction circuit is more than 3. FIG. 10 is a circuit diagram illustrating the circuitry topology of a multi-level power factor correction circuit according to a fifth embodiment of the present disclosure. In this embodiment, the number of levels of the multi-level power factor correction circuit if is N, wherein N is an integer greater than 3. Furthermore, the multi-level power factor correction circuit if includes (N−1) first switches S1, S3 . . . , S(2N−3), (N−1) second switches S2, S4 . . . , S(2N−2), and (N−2) flying capacitors Cfly1, Cfly2 . . . , Cfly(N−2). The first terminal of the k-th flying capacitor is connected with the node between the k-th first switch and the (k+1)-th first switch. The second terminal of the k-th flying capacitor is connected with the node between the k-th second switch and the (k+1)-th second switch. The value k is a positive integer less than or equal to (N−2). The circuitry topology and the control method of the multi-level power factor correction circuit if are similar to those of the multi-level power factor correction circuit 1, and not redundantly described herein.

From the above descriptions, the present disclosure provides the multi-level power factor correction circuit. When the input voltage is in the surge condition, the multi-level power factor correction circuit enters the surge protection mode under control of the control unit. Consequently, the two first switches, the two second switches, the first polarity switch and the second polarity switch are maintained in the turn-off state. When compared with the conventional power factor correction circuit, the input current of the multi-level power factor correction circuit of the present disclosure will not flow through the flying capacitor. Since the voltage on the flying capacitor is very stable and not over-charged, the security of the multi-level power factor correction circuit is enhanced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-level power factor correction circuit, wherein the multi-level power factor correction circuit is an N-level power factor correction circuit, N is an integer greater than or equal to 3, and the multi-level power factor correction circuit comprises:
a first input terminal and a second input terminal configured to receive an input voltage;
a first output terminal and a second output terminal configured to provide an output voltage;
an inductor, wherein a first terminal of the inductor is connected to the second input terminal;
(N−1) first switches serially connected between a second terminal of the inductor and the second output terminal;
(N−1) second switches serially connected between the second terminal of the inductor and the first output terminal;
(N−2) flying capacitors, wherein a first terminal of a k-th flying capacitor is connected with a node between a k-th first switch and a (k+1)-th first switch, and a second terminal of the k-th flying capacitor is connected with a node between a k-th second switch and a (k+1)-th second switch, wherein k is a positive integer less than or equal to (N−2);
a first polarity switch connected between the first input terminal and the first output terminal;
a second polarity switch connected between the first input terminal and the second output terminal; and
a control unit configured to control a working state of the multi-level power factor correction circuit according to the input voltage, wherein when the input voltage is in a surge condition, the multi-level power factor correction circuit enters a surge protection mode under control of the control unit, wherein in the surge protection mode, the first polarity switch, the second polarity switch, the (N−1) first switches and the (N−1) second switches are controlled to be turned off.

2. The multi-level power factor correction circuit according to claim 1, wherein the control unit comprises a surge current sampling module and a surge determination module, wherein when the surge condition occurs, the surge current sampling module samples a surge current and generates a surge current sampled signal, and the surge determination module receives the surge current sampled signal from the surge current sampling module, wherein when the surge determination module determines that the surge current sampled signal is greater than a surge protection threshold, the surge determination module generates a triggering signal, and the multi-level power factor correction circuit is triggered to enter the surge protection mode in response to the triggering signal.

3. The multi-level power factor correction circuit according to claim 2, wherein the multi-level power factor correction circuit further comprises a bypass unit, wherein when the surge condition occurs, the surge current flow through a loop defined by the bypass unit and the second polarity switch, or the surge current flow through a loop defined by the bypass unit and the first polarity switch.

4. The multi-level power factor correction circuit according to claim 3, wherein the bypass unit comprises a first diode and a second diode, wherein the first diode and the second diode are sequentially connected between the first output terminal and the second output terminal, and a diode midpoint between the first diode and the second diode is coupled to the first terminal of the inductor.

5. The multi-level power factor correction circuit according to claim 4, wherein the diode midpoint is connected to the first terminal of the inductor through the surge current sampling module.

6. The multi-level power factor correction circuit according to claim 4, wherein a first terminal and a second terminal of the surge current sampling module are respectively connected with a midpoint between the first polarity switch and the second polarity switch and the first input terminal, or the first terminal and the second terminal of the surge current sampling module are respectively connected with the second input terminal and the first terminal of the inductor.

7. The multi-level power factor correction circuit according to claim 2, wherein when the surge protection mode is erroneously triggered, the multi-level power factor correction circuit exits from the surge protection mode under control of the control unit.

8. The multi-level power factor correction circuit according to claim 7, wherein an erroneous triggering threshold is set in the control unit according to an output current peak value of the multi-level power factor correction circuit in a normal working state, wherein the surge protection threshold is greater than the erroneous triggering threshold.

9. The multi-level power factor correction circuit according to claim 7, wherein the control unit comprises an erroneous trigger determination module for determining whether the surge protection mode is erroneously triggered, wherein when the erroneous trigger determination module determines that the surge protection mode is erroneously triggered, the erroneous trigger determination module generates an erroneous triggering signal.

10. The multi-level power factor correction circuit according to claim 9, wherein the erroneous trigger determination module determines whether the surge protection mode is erroneously triggered according to a result of determining whether an input voltage sampled signal and/or the surge current sampled signal is within a threshold range.

11. The multi-level power factor correction circuit according to claim 10, wherein when M consecutive input voltage sampled signals and/or M consecutive surge current sampled signals are all within the threshold range, the erroneous trigger determination module determines that the surge protection mode is erroneously triggered, wherein when the M consecutive input voltage sampled signals and/or the M consecutive surge current sampled signals are not all within the threshold range, the erroneous trigger determination module determines that the surge protection mode is not erroneously triggered, wherein M is greater than or equal to 2.

12. The multi-level power factor correction circuit according to claim 7, wherein the control unit further comprises a masking module, and the masking module is connected between the surge current sampling module and the surge determination module, or the masking module is connected with an output terminal of the surge determination module, wherein when the surge protection mode is erroneously triggered, the surge current sampled signal is masked by the masking module, so that the multi-level power factor correction circuit exits from the surge protection mode.

13. The multi-level power factor correction circuit according to claim 12, wherein the masking module comprises a driving circuit and a masking switch, and the masking switch receives an erroneous triggering signal through the driving circuit, wherein when the erroneous triggering signal is valid, the masking switch is controlled to be turned on, the surge current sampled signals is pulled down to be lower than the surge protection threshold, and the surge current sampled signal is masked, so that the multi-level power factor correction circuit exits from the surge protection mode.

14. The multi-level power factor correction circuit according to claim 3, wherein the surge current sampling module comprises a sampling circuit and a voltage shaping circuit, wherein the sampling circuit samples the surge current and outputs a sampled current information to the voltage shaping circuit, and the voltage shaping circuit outputs the surge current sampled signal according to the current information, wherein the sampling circuit comprises a current transformer or a sampling resistor.

15. A surge protection control method for a multi-level power factor correction circuit, wherein the multi-level power factor correction circuit is an N-level power factor correction circuit, N is an integer greater than or equal to 3, and the multi-level power factor correction circuit comprises a first input terminal, a second input terminal, a first output terminal, a second output terminal, an inductor, (N−1) first switches, (N−1) second switches, (N−2) flying capacitors and a control unit, the first input terminal and the second input terminal are configured to receive an input voltage, the first output terminal and the second output terminal are configured to provide an output voltage, a first terminal of the inductor is connected to the second input terminal, the (N−1) first switches are serially connected between a second terminal of the inductor and the second output terminal, the (N−1) second switches are serially connected between the second terminal of the inductor and the first output terminal, a first terminal of a k-th flying capacitor is connected with a node between a k-th first switch and a (k+1)-th first switch, a second terminal of the k-th flying capacitor is connected with a node between a k-th second switch and a (k+1)-th second switch, k is a positive integer less than or equal to (N−2), the first polarity switch is connected between the first input terminal and the first output terminal, the second polarity switch is connected between the first input terminal and the second output terminal, the surge protection control method comprises steps of:
controlling a working state of the N-level power factor correction circuit according to the input voltage; and
when the input voltage is in a surge condition, allowing the N-level power factor correction circuit to enter a surge protection mode, wherein in the surge protection mode, the first polarity switch, the second polarity switch, the (N−1) first switches and the (N−1) second switches are controlled to be turned off.

16. The surge protection control method according to claim 15, wherein surge protection control method further comprises a step of sampling a surge current and generating a surge current sampled signal when the surge condition occurs, wherein when the surge current sampled signal is greater than a surge protection threshold, a triggering signal is generated, and the N-level power factor correction circuit is triggered to enter the surge protection mode in response to the triggering signal.

17. The surge protection control method according to claim 16, wherein the surge protection control method further comprises a step of generating an erroneous triggering signal when the surge protection mode is erroneously triggered, wherein the N-level power factor correction circuit exits from the surge protection mode in response to the erroneous triggering signal.

18. The surge protection control method according to claim 17, wherein the surge protection control method further comprises a step of determining whether the surge protection mode is erroneously triggered according to a result of determining whether an input voltage sampled signal and/or the surge current sampled signal is within a threshold range.

19. The surge protection control method according to claim 18, wherein when M consecutive input voltage sampled signals and/or M consecutive surge current sampled signals are all within the threshold range, the erroneous trigger determination module determines that the surge protection mode is erroneously triggered, wherein when the M consecutive input voltage sampled signals and/or the M consecutive surge current sampled signals are not all within the threshold range, the erroneous trigger determination module determines that the surge protection mode is not erroneously triggered, wherein M is greater than or equal to 2.

20. The surge protection control method according to claim 17, wherein the surge protection control method further comprises a step of adjusting the surge protection threshold to be greater than an erroneous triggering threshold, wherein the erroneous triggering threshold is set according to an output current peak value of the N-level power factor correction circuit in a normal working state.

21. The surge protection control method according to claim 17, wherein the N-level power factor correction circuit further comprises a masking module, wherein when the erroneous triggering signal is received, the surge current sampled signal is masked by the masking module, so that the N-level power factor correction circuit exits from the surge protection mode.
